(19) United States
(12) Patent Application Publication
(10) Pub. No.: US 2026/0312337 A1
(43) Pub. Date: Oct. 8, 2026

(54) CONNECTOR DEVICE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Nungna WI, Mie (JP); Daisuke SAITO, Mie (JP)

(21) Appl. No.: 19/480,830

(22) PCT Filed: May 7, 2024
(86) PCT No.: PCT/JP2024/016952

§ 371 Date: Nov. 3, 2025

(30) Foreign Application Priority Data
May 9, 2023 (JP) 2023-077254

(51) Int. Cl. H01R 13/629; H01R 13/50; H01R 13/645

(52) U.S. Cl. CPC H01R 13/62905; H01R 13/50; H01R 13/6453; H01R 2201/26

(57) ABSTRACT

A first connector includes a first housing. A second connector includes a second housing connectable to the first housing, a moving plate to be positioned with respect to the first housing and a guide member for movably supporting the moving plate and the second housing. The moving plate includes a positioning portion to be engaged with a positioning receiving portion of the first housing in an approach direction of the first and second connectors. The first and second housings are arranged at a connection start position with the moving plate positioned with respect to the first housing. The guide member includes a cam portion for moving the second housing in a connection direction intersecting the approach direction with respect to the first housing.

### TECHNICAL FIELD

The present disclosure relates to a connector device.

### BACKGROUND

Patent Document 1 discloses a connector connection device for connecting a second connection device on a battery unit side to a first connection device on an electric vehicle side.

### PRIOR ART DOCUMENT

### Patent Document

Patent Document 1: JP 2010-272242 A

### SUMMARY OF THE INVENTION

### Problems to be Solved

This connector device is configured to position the first and second connection devices by a guide member extending from a base portion and a guide pole extending from a main fixing plate. However, since a female connector and a male connector are configured to be positioned via the guide pole, a main plate, a second side wall, a third side wall, a fixing sub-plate, the base portion, a first mounting bracket and the guide member, even if the first and second connection devices are positioned by the guide member and the guide pole, it may not be possible to sufficiently suppress relative position variations of the female and male connectors.

The present disclosure was developed on the basis of the above situation and aims to provide a connector device reliably connectable while suppressing an influence of variations.

### Means to Solve the Problem

The present disclosure is directed to a connector device with a first connector and a second connector capable of approaching and separating from each other, the first connector including a first housing, the second connector including a second housing connectable to the first housing, a positioning member to be positioned with respect to the first housing and a guide member for movably supporting the positioning member and the second housing, the first housing including a positioning receiving portion, the positioning member including a positioning portion to be engaged with the positioning receiving portion in an approach direction of the first and second connectors, the first and second housings being arranged at a connection start position with the positioning member positioned with respect to the first housing, and the guide member including a cam portion for moving the second housing in a connection direction intersecting the approach direction with respect to the first housing.

### Effect of the Invention

According to the present disclosure, a connector device can be reliably connected while an influence of variations is suppressed.

### BRIEF DESCRIPTION OF THE DRAWINGS

FIG. 1 is a side view of a connector device of one embodiment.

FIG. 2 is an exploded perspective view of the connector device of the embodiment.

FIG. 3 is a side view of a first housing.

FIG. 4 is a perspective view of the first housing when viewed from below.

FIG. 5 is a perspective view of a support member when viewed from below.

FIG. 6 is a perspective view of a second housing when viewed from below.

FIG. 7 is a perspective view of a moving plate when viewed from front.

FIG. 8 is a perspective view of the moving plate when viewed from above.

FIG. 9 is a perspective view of a guide member when viewed from front.

FIG. 10 is a side view showing a state where the first housing having female terminal fittings mounted therein is mounted in the support member.

FIG. 11 is a side view showing a state where the moving plate is mounted in the guide member.

FIG. 12 is a side view showing a state where a male terminal fitting is mounted in the second housing.

FIG. 13 is a side view showing a state where the second housing is mounted in the guide member having the moving plate mounted therein.

FIG. 14 is a side view in section of the moving plate and the second housing showing a state where protrusions of the second housing are located in intermediate parallel zones of second cam grooves.

FIG. 15 is a side view in section of the connector device showing a state where the lower surface of a positioning receiving body is in contact with the upper surface of an accommodating portion of the moving plate.

FIG. 16 is a side view in section of the connector device showing a state where the connection of the first and second housings is completed.

### DETAILED DESCRIPTION TO EXECUTE THE INVENTION

### [Description of Embodiments of Present Disclosure]

First, embodiments of the present disclosure are listed and described.

(1) The connector device is provided with a first connector and a second connector capable of approaching and separating from each other, the first connector including a first housing, the second connector including a second housing connectable to the first housing, a positioning member to be positioned with respect to the first housing and a guide member for movably supporting the positioning member and the second housing, the first housing including a positioning receiving portion, the positioning member including a positioning portion to be engaged with the positioning receiving portion in an approach direction of the first and second connectors, the first and second housings being arranged at a connection start position with the positioning member positioned with respect to the first housing, and the guide member including a cam portion for moving the second housing in a connection direction intersecting the approach direction with respect to the first housing.

In the connector device of (1), after the first and second housings are arranged at the connection start position by the positioning member, the second housing can be moved in the connection direction by the cam portion of the guide member. Thus, relative position variations of the first and second housings can be suppressed to be small, and the first and second housings tend to be satisfactorily connected. That is, since the second connector includes the positioning member, positioning accuracy can be enhanced.

(2) In the connector device of (1), the positioning member is a moving plate movable to an initial position and a connection position with respect to the second housing, the moving plate protecting a tab of a male terminal fitting mounted in the second housing at the initial position.

In the connector device of (2), since the first and second housings are arranged at the connection start position with the moving plate positioned with respect to the first housing, a connecting operation of the first and second housings thereafter can be satisfactorily performed. That is, the positioning member can have a positioning function with respect to the first housing in addition to a function of protecting the tab.

(3) In the connector device of (1), the first connector includes a support member for movably supporting the first housing in a direction intersecting the approach direction.

In the connector device of (3), the first housing is movable in the direction intersecting the approach direction with respect to the support member. Thus, even if the second connector swings with respect to the first connector while the connection of the first and second housings proceeds, the first housing can follow the second housing and the connection of the first and second housings is not hindered.

(4) In the connector device of (1), the positioning portion is in the form of a shaft extending in the approach direction, and the positioning portion and the positioning receiving portion include a rotation restricting portion for restricting rotation of the positioning portion about an axis with respect to the positioning receiving portion.

In the connector device of (4), an operation of bringing the first and second housings closer is easily stabilized.

[Details of Embodiment of Present Disclosure]

### <Embodiment>

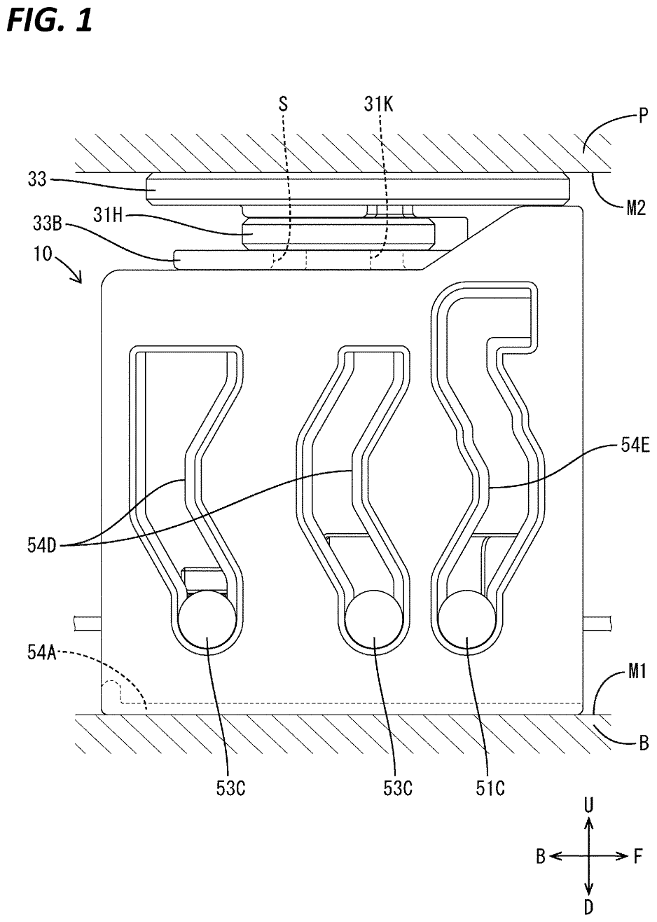

One specific embodiment of a connector device 10 of the present disclosure is described with reference to FIGS. 1 to 16. In figures, a “front side”, a “back side”, an “upper side”, a “lower side”, a “right side” and a “left side” are respectively denoted by “F”, “B”, “U”, “D”, “R” and “L”. A vertical direction is an approach direction of a first connector 30 and a second connector 50. A front-back direction is a connection direction of a first housing 31 and a second housing 51.

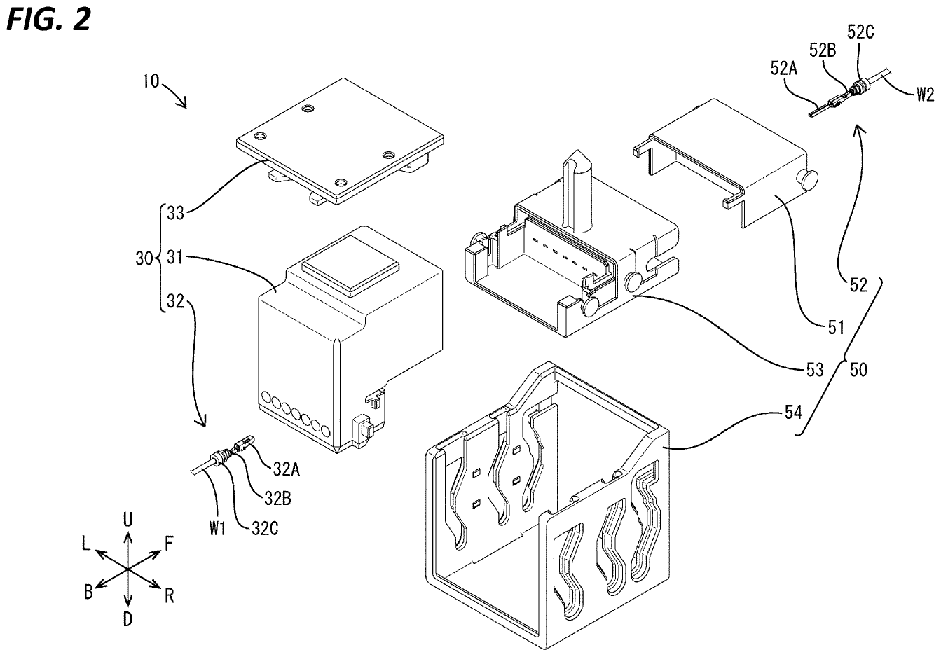

As shown in FIG. 1, the connector device 10 is provided between a base portion B having a first mounting surface M1 and a facing portion P having a second mounting surface M2 facing the first mounting surface M1, the base portion B and the facing portion P being capable of approaching and separating from each other. For example, the base portion B corresponds to a chassis in a vehicle, and the facing portion P corresponds to a body in the vehicle. As shown in FIG. 2, the connector device 10 is provided with the first connector 30 and the second connector 50. The first connector 30 includes the first housing 31, which is a female housing, female terminal fittings 32 and a support member 33. The second connector 50 includes the second housing 51, which is a male housing, male terminal fittings 52, a moving plate 53, which is a positioning member, and a guide member 54.

### [Configuration of First Housing]

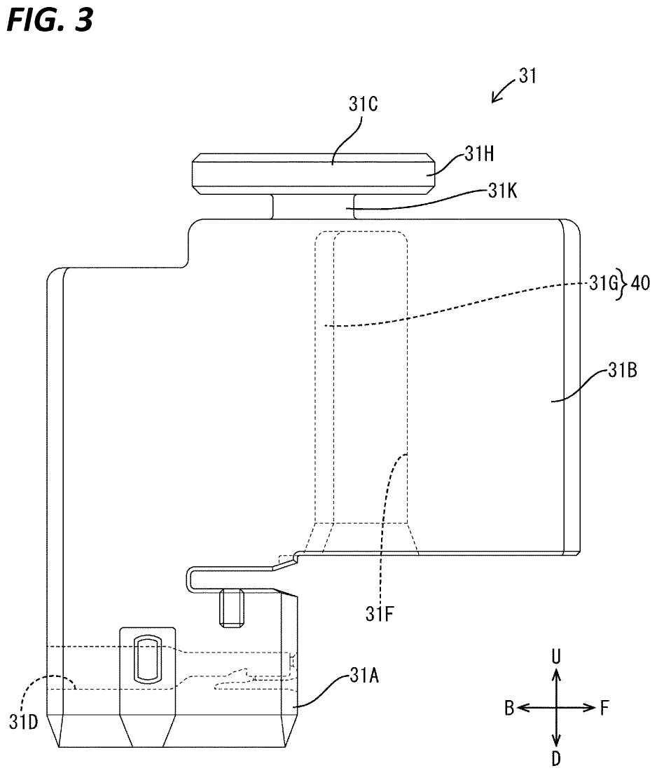

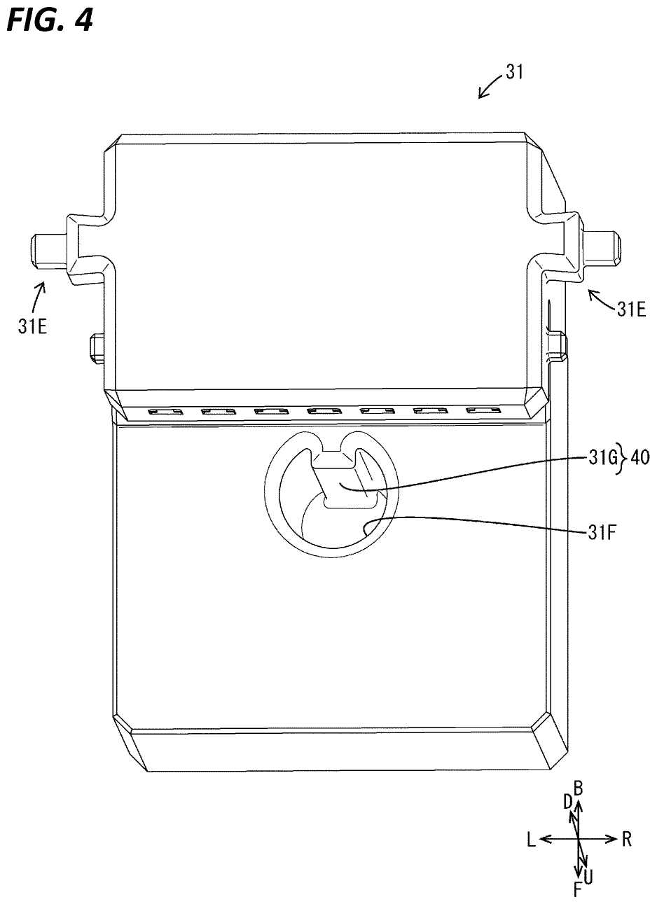

The first housing 31 is, for example, made of insulating synthetic resin. As shown in FIG. 3, the first housing 31 includes a first housing body 31A, a positioning receiving body 31B and a locking portion 31C. The first housing body 31A is block-like. The first housing body 31A is formed with a plurality of first cavities 31D penetrating in the front-back direction. A pair of protrusions 31E are provided to project outward in a lateral direction on both end parts in the lateral direction of the first housing body 31A (see FIG. 4). A base part of each protrusion 31E is obliquely formed to expand a width in the front-back direction toward an outer side in the lateral direction (see FIG. 4).

The positioning receiving body 31B is block-like. The positioning receiving body 31B is arranged above the first housing body 31A. The positioning receiving body 31B and the first housing body 31A are so connected that the back surfaces thereof are flush with each other. The positioning receiving body 31B is formed with a positioning receiving portion 31F recessed upward from a lower surface. The positioning receiving portion 31F includes a rotation restricting protrusion 31G, which constitutes a rotation restricting portion 40. The rotation restricting protrusion 31G, which constitutes the rotation restricting portion 40, is provided to project inward from the inner surface of the positioning receiving portion 31F (see FIG. 4).

The locking portion 31C is provided to project upward from the upper surface of the positioning receiving body 31B. An upper end part of the locking portion 31C is formed with a flange portion 31H in the form of a flange protruding in the front-back direction and the lateral direction. A lower part of the locking portion 31C is formed as a supporting portion 31K for supporting the flange portion 31H.

### [Configuration of Female Terminal Fitting]

The female terminal fitting 32 is made of electrically conductive metal. As shown in FIG. 2, the female terminal fitting 32 is shaped to extend in the front-back direction. The female terminal fitting 32 includes a connecting portion 32A in the form of a rectangular tube and a barrel portion 32B in the form of an open barrel arranged behind the connecting portion 32A. A tab 52A of the male terminal fitting 52 to be described later is inserted into the connecting portion 32A. The barrel portion 32B is connected to an end part of a wire W1. A rubber plug 32C is fit on the outer peripheral surface of the wire W1. The barrel portion 32B includes a part to be crimped to the rubber plug 32C. The rubber plug 32C is inserted into the first cavity 31D in a liquid-tight manner.

### [Configuration of Support Member]

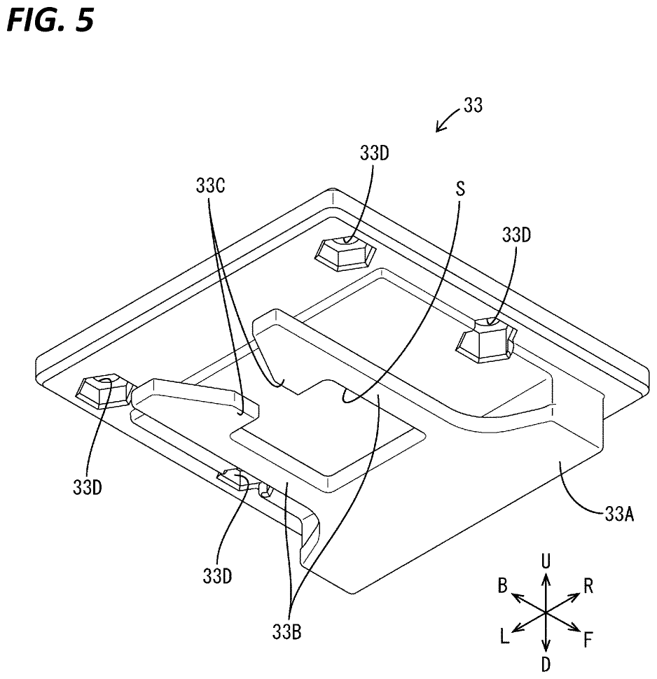

The support member 33 is, for example, made of insulating synthetic resin. As shown in FIG. 5, the support member 33 has a flat rectangular shape. The support member 33 is formed with a plurality of through holes 33D penetrating in a plate thickness direction. For example, the support member 33 is fixed to the facing portion P by bringing the upper surface thereof into contact with the second mounting surface M2 of the facing portion P and inserting bolts through the through holes 33D (see FIG. 1). A base portion 33A is provided to project downward on a front end edge part of the support member 33. A pair of resilient deforming portions 33B are provided to extend backward on a lower end part of the base portion 33A. The pair of resilient deforming portions 33B are arranged apart from each other in the lateral direction to form a swing space S. Detachment restricting portions 33C projecting inward in the lateral direction are provided on back end parts (tip parts) of the pair of resilient deforming portions 33B. The supporting portion 31K of the locking portion 31C of the first housing 31 is locked between the pair of resilient deforming portions 33B of the support member 33 from behind. Specifically, the flange portion 31H is arranged to be sandwiched between the support member 33 and the pair of resilient deforming portions 33B (see FIG. 1). The supporting portion 31K of the locking portion 31C is arranged in the swing space S. The locking portion 31C is movable in the front-back direction and the lateral direction in a formation range of the swing space S. The support member 33 movably supports the first housing 31 in a direction intersecting the approach direction (vertical direction).

### [Configuration of Second Housing]

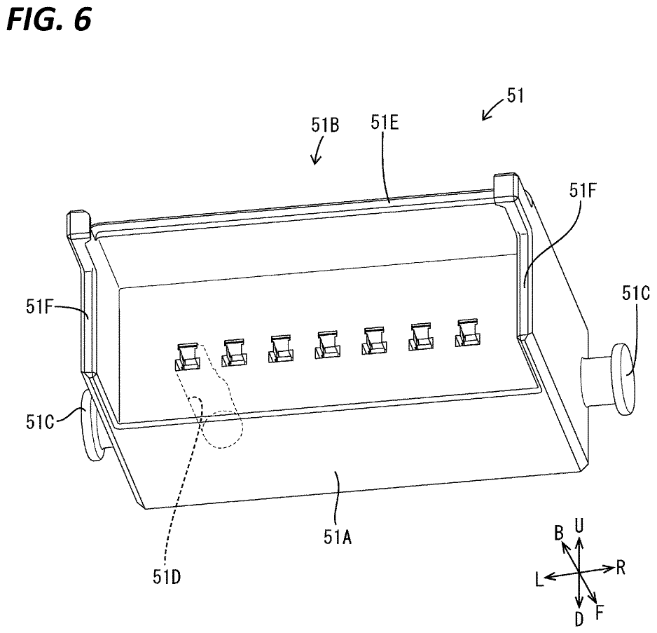

The second housing 51 is, for example, made of insulating synthetic resin. The second housing 51 is connectable to the first housing 31. As shown in FIG. 6, the second housing 51 includes a second housing body 51A, a receptacle 51B and a pair of protrusions 51C. The second housing body 51A is block-like. The second housing body 51A is formed with a plurality of second cavities 51D penetrating in the front-rear direction. The plurality of second cavities 51D are arranged side by side in the lateral direction. The receptacle 51B includes a first wall portion 51E and a pair of second wall portions 51F. The first wall portion 51E is in the form of a flat plate extending backward along an upper end edge part of the second housing body 51A. The pair of second wall portions 51F are in the form of flat plates respectively extending backward from both left and right end parts of the second housing body 51A. The pair of second wall portions 51F hang down from both ends in the lateral direction of the first wall portion 51E. The pair of protrusions 51C are provided to project outward in the lateral direction from front end parts of both end surfaces in the lateral direction of the second housing body 51A. A tip part of each protrusion 51C is in the form of an expanded flange.

### [Configuration of Male Terminal Fitting]

The male terminal fitting 52 is made of electrically conductive metal. As shown in FIG. 2, the male terminal fitting 52 is shaped to extend in the front-rear direction. The male terminal fitting 52 includes the elongated tab 52A and a barrel portion 52B in the form of an open barrel arranged in front of the tab 52A. The barrel portion 52B is connected to an end part of a wire W2. A rubber plug 52C is fit on the outer peripheral surface of the wire W2. The barrel portion 52B includes a part to be crimped to the rubber plug 52C. The rubber plug 52C is inserted into the second cavity 51D in a liquid-tight manner.

### [Configuration of Moving Plate]

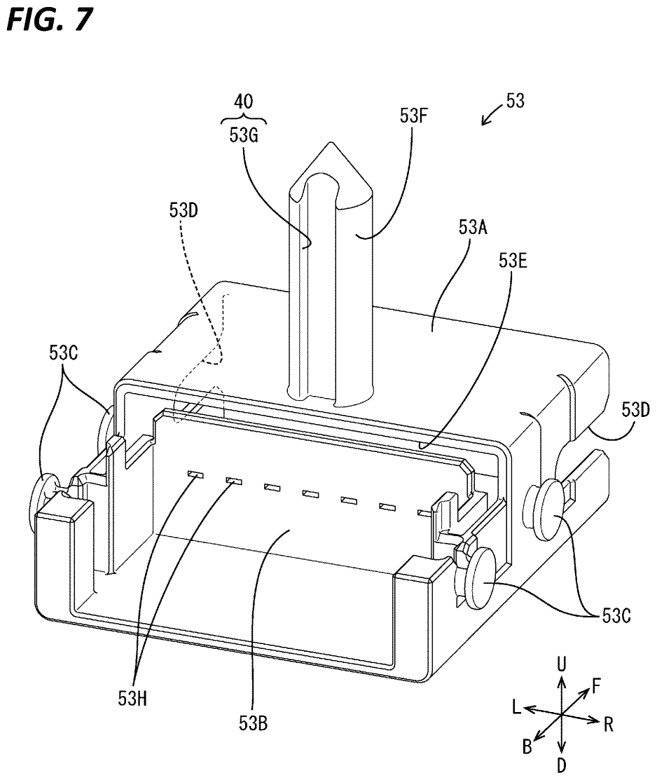

The moving plate 53 is, for example, made of insulating synthetic resin. As shown in FIG. 7, the moving plate 53 includes an accommodating portion 53A in the form of a rectangular tube, a moving plate body 53B, a plurality of protrusions 53C and a positioning portion 53F. The accommodating portion 53A is in the form of a rectangular tube and formed to extend in the front-rear direction. A back part of the accommodating portion 53A is open upward. Each of left and right side walls of a front part of the accommodating portion 53A is formed with a recess 53D recessed backward from a front end. The moving plate body 53B is in the form of a flat plate having a plate thickness direction oriented in the front-rear direction. The moving plate body 53B is formed with a plurality of through holes 53H penetrating in the plate thickness direction. The moving plate body 53B is arranged in a central part in the front-rear direction of the accommodating portion 53A and connected to the lower wall of the accommodating portion 53A. The upper and both left and right end edges of the moving plate body 53B are separated from the accommodating portion 53A by a predetermined dimension to form a gap 53E.

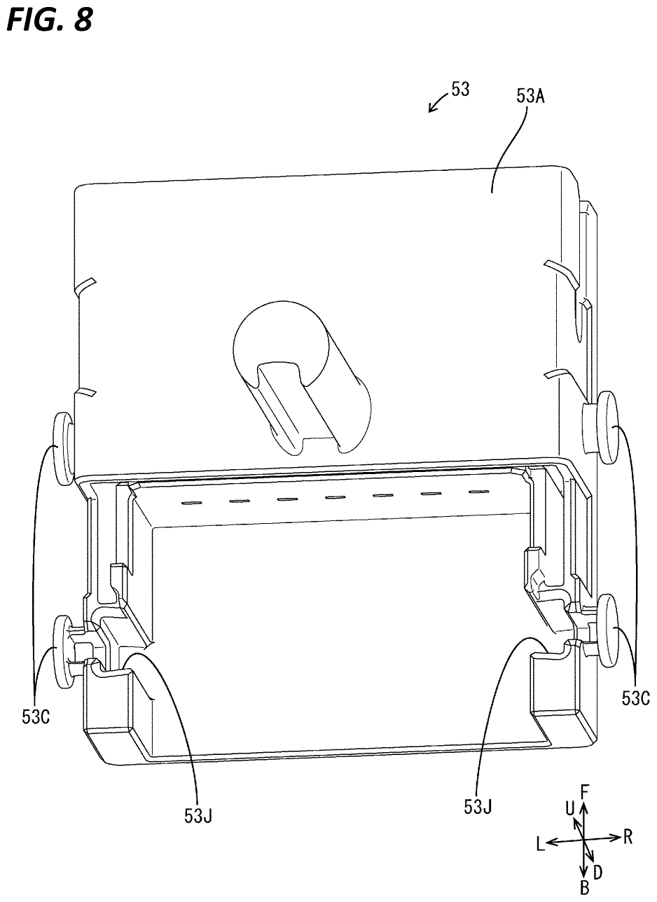

Tip parts of the plurality of protrusions 53C are in the form of expanded flanges. Two protrusions 53C are provided to project outward in the lateral direction on each of both end surfaces in the lateral direction of the accommodating portion 53A. Specifically, on each of the both end surfaces in the lateral direction of the accommodating portion 53A, one protrusion 53C is arranged in a central part in the front-rear direction and one protrusion 53C is arranged in a back end part. Lightening portions 53J are formed to be recessed outward from laterally inner sides in parts of the left and right side walls of the accommodating portion 53A where the protrusions 53C in the back end part are arranged (see FIG. 8). Each lightening portion 53J is formed into a dovetail groove to expand a width in the front-rear direction toward an outer side in the lateral direction (see FIG. 8).

The positioning portion 53F is in the form of a shaft provided to extend upward from the upper surface of the accommodating portion 53A. Specifically, the positioning portion 53F has a cylindrical shape. An upper end part (tip part) of the positioning portion 53F is formed into a conical shape reduced in diameter toward an upper end. The positioning portion 53F includes a rotation restricting recess 53G, which constitutes the rotation restricting portion 40. The rotation restricting recess 53G, which constitutes the rotation restricting portion 40, is in the form of a groove extending in an axial direction in the outer peripheral surface of the positioning portion 53F.

### [Configuration of Guide Member]

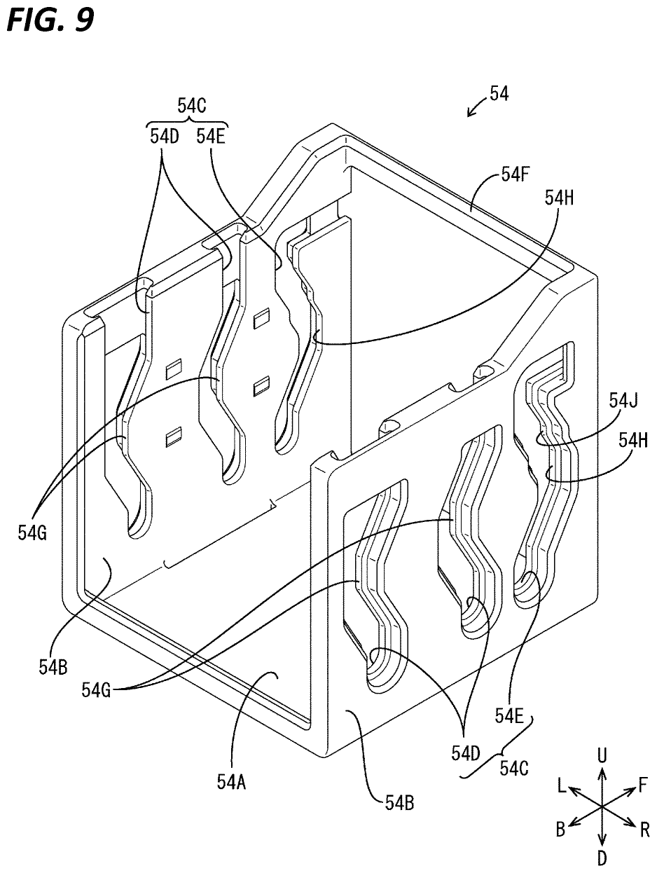

The guide member 54 is, for example, made of insulating synthetic resin. The guide member 54 movably supports the moving plate 53 and the second housing 51. As shown in FIG. 9, the guide member 54 includes a flat plate-like bottom wall portion 54A and a pair of flat plate-like left and right side wall portions 54B respectively rising upward from both end edges in the lateral direction of the bottom wall portion 54A. Front end parts of the respective upper end parts of the pair of left and right side wall portions 54B are coupled by a reinforcement column 54F extending in the lateral direction. For example, the guide member 54 is arranged to bring the bottom wall portion 54A into contact with the first mounting surface M1 of the base portion B, and fixed to the base portion B (see FIG. 1).

A cam portion 54C is formed to penetrate through each of the pair of left and right side wall portions 54B in a plate thickness direction. The cam pin 54C includes first cam grooves 54D and a second cam groove 54E. The first cam grooves 54D are formed side by side in a central part and a back part in the front-rear direction of each of the left and right side wall portions 54B. The first cam groove 54D is formed to extend in the vertical direction and open upward of each of the left and right side wall portions 54B. The second cam groove 54E is formed in a front part of each of the left and right side wall portions 54B. The second cam groove 54E is formed to extend in the vertical direction, bent forward in an upper end part, and open forward of each of the left and right side wall portions 54b.

The first cam grooves 54D and the second cam groove 54E are obliquely formed to be separated from each other in the front-rear direction toward central parts in the vertical direction. Specifically, front and back sides of the front first cam groove 54D are inclined backward from an upper part toward a central part in the front-rear direction and inclined forward from the central part in the vertical direction toward a lower part. A front side of the back first cam groove 54D is inclined backward from an upper part toward a central part in the vertical direction and inclined forward from the central part in the vertical direction toward a lower part. A back side of the back first cam groove 54D extends in the vertical direction from an upper part toward a central part in the vertical direction and is inclined forward from the central part in the vertical direction toward a lower part. Front and back sides of the second cam groove 54E are inclined forward from an upper part toward a central part in the vertical direction and inclined backward from the central part in the vertical direction toward a lower part.

A first parallel zone 54G is formed in the central part in the vertical direction of the first cam groove 54D. The first parallel zone 54G extends in the vertical direction and is located behind upper and lower end parts of the first cam groove 54D. A second parallel zone 54H is formed in the central part in the vertical direction of the second cam groove 54E. The second parallel zone 54H extends in the vertical direction and is located in front of upper and lower end parts of the second cam groove 54E. The positions in the vertical direction of the respective first and second parallel zones 54G, 54H overlap in the vertical direction. In the second cam groove 54E, an intermediate parallel zone 54J is formed above the second parallel zone 54H. The intermediate parallel zone 54J extends in the vertical direction and is located in front of the upper and lower end parts of the second cam groove 54E and behind the second parallel zone 54H. The respective lower end parts of the first and second cam grooves 54D, 54E extend in the vertical direction and are parallel to each other.

### [Assembly Example of Connector Device]

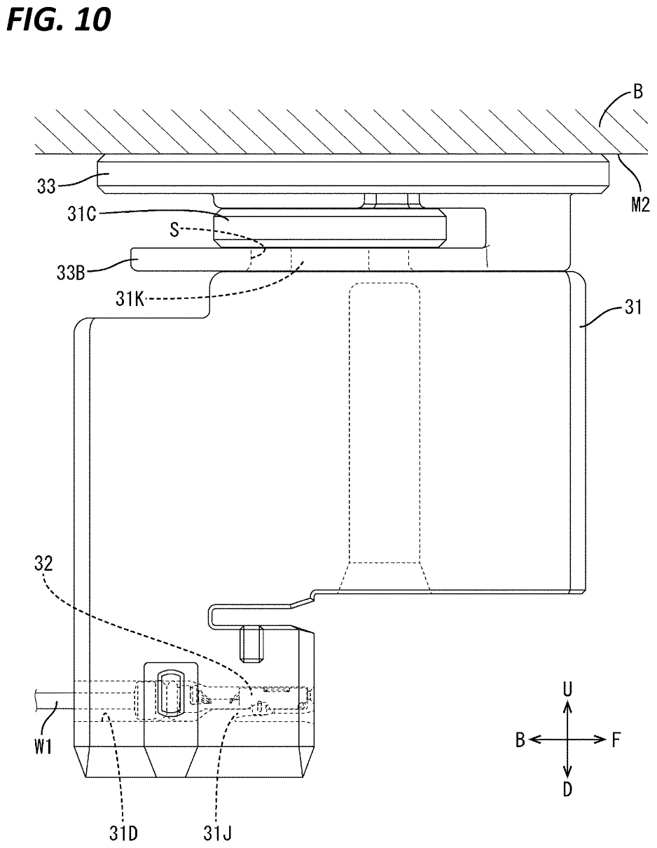

Next, an assembly example of the connector device 10 is described. As shown in FIG. 10, the female terminal fitting 32 connected to the end part of the wire W1 is first accommodated into each first cavity 31D of the first housing 31. The female terminal fitting 32 accommodated in the first cavity 31D is retained by a locking lance 31 provided in the first cavity 31D. The supporting portion 31K of the locking portion 31C is arranged in the swing space S between the pair of resilient deforming portions 33B of the support member 33. The supporting portion 31K arranged in the swing space S is restricted from coming out from the swing space S by the detachment restricting portions 33C. Then, the support member 33 is mounted on the second mounting surface M2 of the facing portion P.

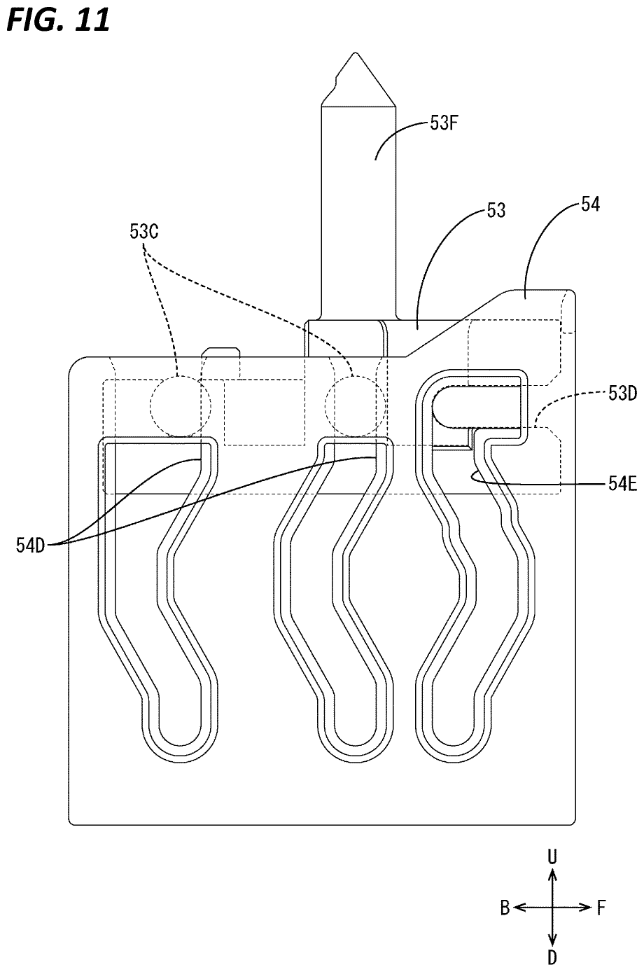

Further, as shown in FIG. 11, the moving plate 53 is mounted into the guide member 54. Specifically, the positioning portion 53F is set in a posture extending in the approach direction (vertical direction) and the respective protrusions 53C are inserted into the first cam grooves 54D from above. At this time, the moving plate 53 is so arranged that the recesses 53D overlap forward bent parts of the upper end parts of the second cam grooves 54E.

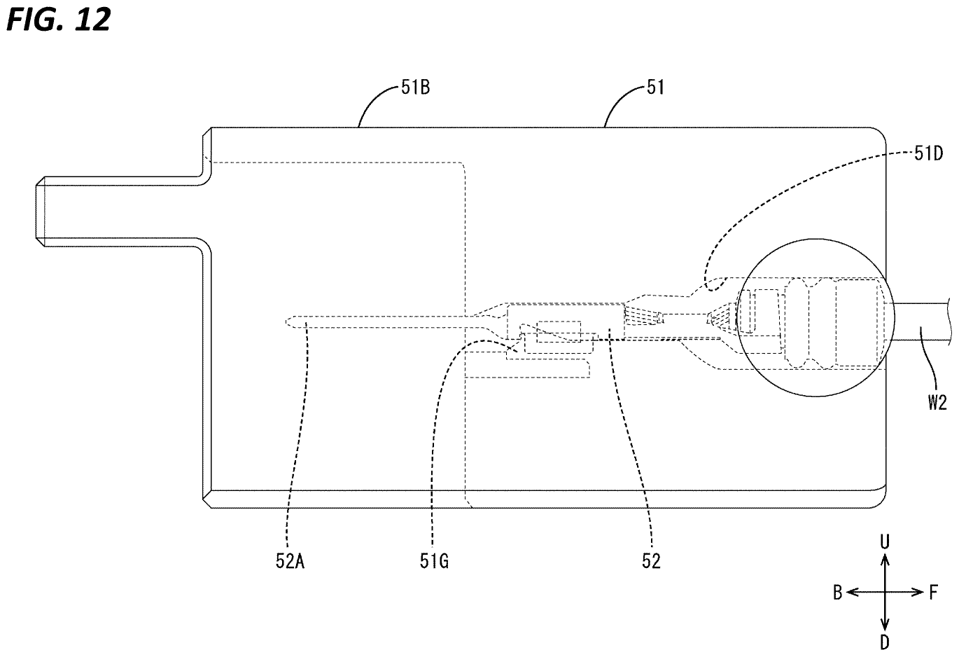

Further, as shown in FIG. 12, the male terminal fitting 52 connected to the end part of the wire W2 is accommodated into each second cavity 51D of the second housing 51. The male terminal fitting 52 accommodated in the second cavity 51D is retained by a locking lance 51G provided in the second cavity. The tab 52A of the male terminal fitting 52 is arranged in a space surrounded by the receptacle 51B.

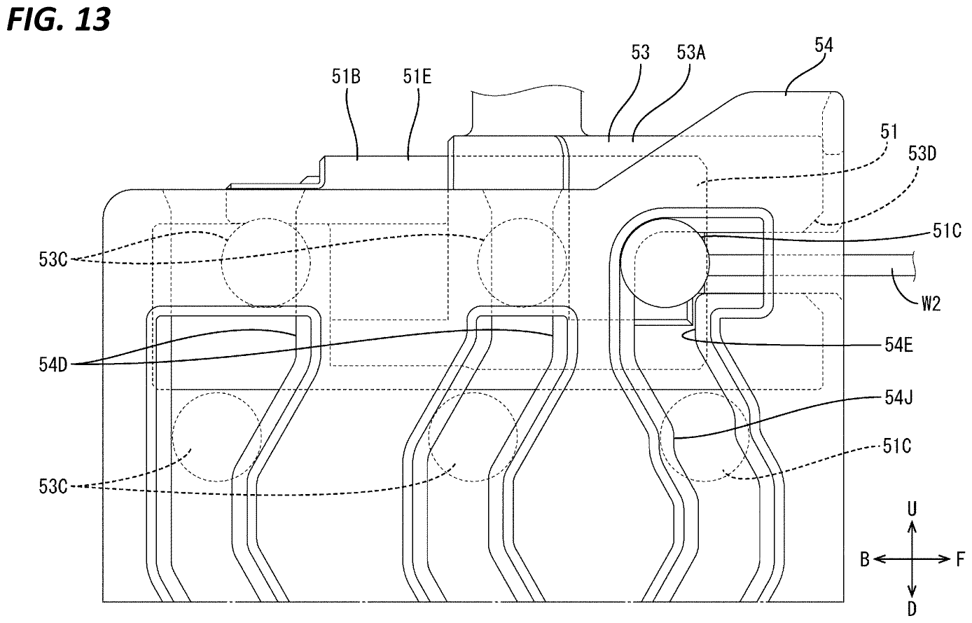

Subsequently, as shown in FIG. 13, the second housing 51 having the male terminal fittings 52 mounted therein is mounted into the guide member 54 having the moving plate 53 mounted therein. Specifically, the second housing 51 is set in such a posture that the first wall portion 51E of the receptacle 51B is arranged on an upper side while the wires W2 are pulled out forward, and inserted into the accommodating portion 53A of the moving plate 53 from front. Then, each protrusion 51C is inserted into the upper end part of each second cam groove 54E from front, and butted against the back side of the second cam groove 54E while being inserted into the recess 53D of the moving plate 53. At this time, each tab 52A is passed through each insertion hole 53H of the moving plate body 53B (not shown).

Subsequently, the moving plate 53 and the second housing 51 are moved downward with respect to the guide member 54 with the postures thereof maintained. At this time, each protrusion 53C of the moving plate 53 moves downward in the first cam groove 54D, and each protrusion 51C of the second housing 51 moves downward in the second cam groove 54E.

In the process of moving the moving plate 53 and the second housing 51 downward with respect to the guide member 54 with the downward facing postures thereof maintained, the moving plate 53 moves to a back lower side by each protrusion 53C moving along the first cam groove 54D. Along with this, the second housing 51 moves to a front lower side by each protrusion 51C moving along the second cam groove 54E. In this way, the moving plate body 53B and the second housing 51 move relatively away from each other in the front-rear direction.

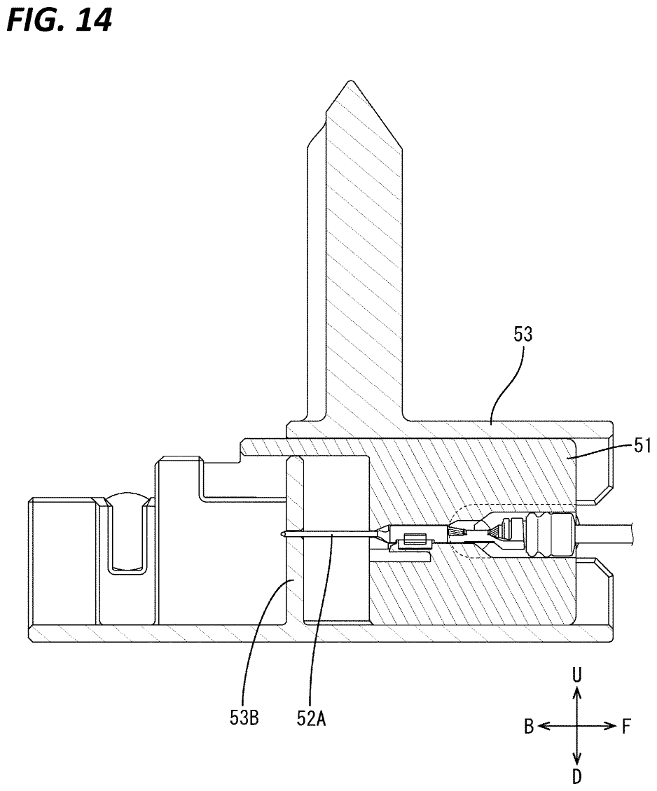

Then, each protrusion 51C of the second housing 51 reaches the intermediate parallel zone 54J of the second cam groove 54E (see FIG. 13). At this time, as shown in FIG. 14, the tab 52A is passed through the moving plate body 53B and the tip part thereof is arranged at a position slightly projecting backward from the moving plate body 53B. At this time, a jig for confirming continuity can be, for example, brought into contact with the tip part of the tab 52A to conduct a continuity check.

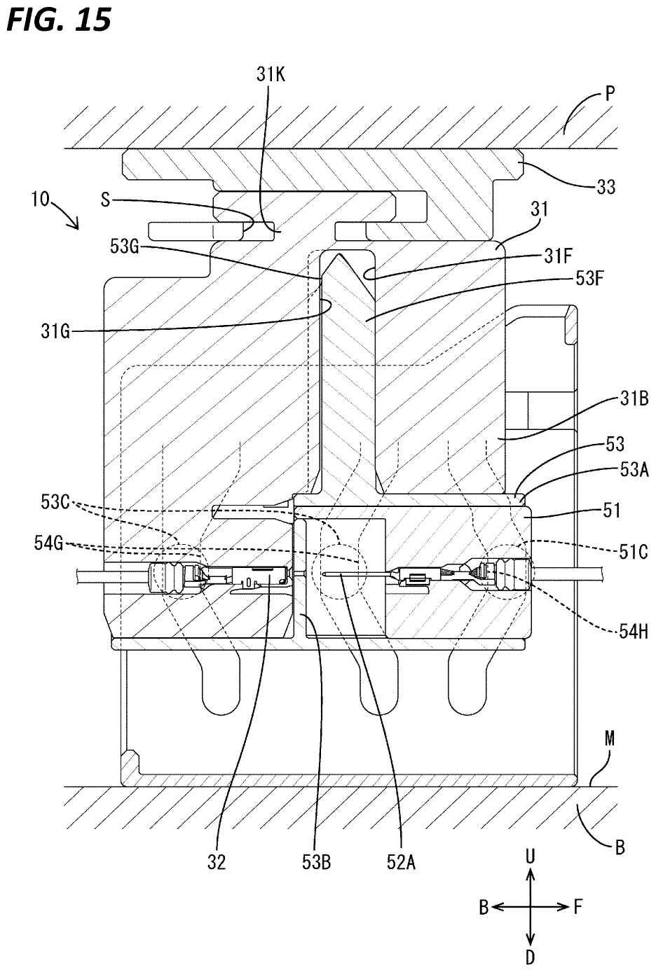

The moving plate 53 and the second housing 51 are further moved downward with respect to the guide member 54. Then, as shown in FIG. 15, each protrusion 51C of the second housing 51 reaches the second parallel zone 54H of the second cam groove 54E. Along with this, each protrusion 53C of the moving plate 53 reaches the first parallel zone 54G of the first cam groove 54D. At this time, the tab 52A is located in front of the moving plate body 53B. The position of the moving plate 53 with respect to the second housing 51 at this time is an initial position. The moving plate 53 protects the tabs 52A of the male terminal fittings 52 mounted in the second housing 51 at the initial position. Then, the guide member 54 is mounted on the first mounting surface M1 of the base portion B.

Subsequently, the facing portion P is brought closer to the base portion B from above, and the first housing 31 having the female terminal fittings 32 mounted therein is fit into the moving plate 53. Specifically, as shown in FIG. 15, the first housing 31 is arranged below the facing portion P, the guide member 54 is arranged above the base portion B and the facing portion P is brought closer to the base portion B from above. Then, the positioning portion 53F is inserted into the positioning receiving portion 31F of the first housing 31. At this time, the rotation restricting protrusion 31G is fit into the rotation restricting recess 53G. In this way, the rotation of the positioning portion 53F about an axis with respect to the positioning receiving portion 31F is restricted.

The positioning portion 53F of the moving plate 53 is inserted into the positioning receiving portion 31F of the first housing 31. Thus, if the facing portion P swings in the lateral direction and the front-rear direction, the support member 33 also swings together with the facing portion P, but the relative position of the first housing 31 with respect to the moving plate 53 is kept.

If the facing portion P is further brought closer to the base portion B, the pair of protrusions 31E of the first housing 31 are inserted into the pair of lightening portions 53J of the moving plate 53 from above. The pair of protrusions 31E and the lightening portions 53J are fit in a dovetail manner (not shown). Thereafter, the lower surface of the positioning receiving body 31B of the first housing 31 comes into surface contact with the upper surface of the accommodating portion 53A of the moving plate 53. At this time, the moving plate 53 is in a state positioned with respect to the first housing 31, and the first housing body 31a and the second housing 51 are facing opposite to each other and arranged at a connection start position (see FIG. 15).

If the facing portion P is further brought closer to the base portion B, the accommodating portion 53A of the moving plate 53 is pressed downward by the positioning receiving body 31B of the first housing 31, whereby the moving plate 53 and the second housing 51 move downward.

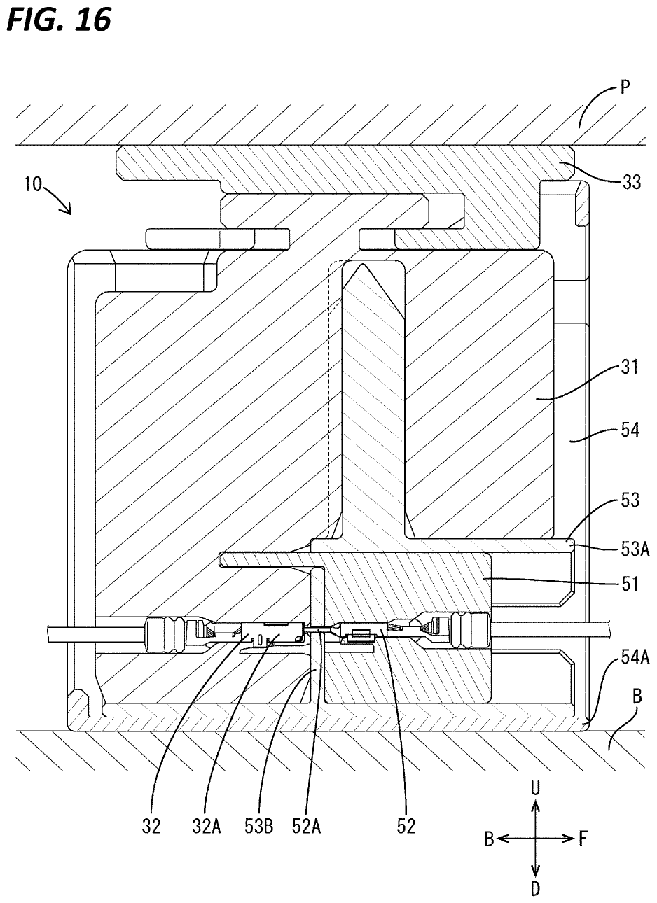

Then, the first housing 31 and the moving plate 53 move to the front lower side by each protrusion 53C of the moving plate 53 moving along the first cam groove 54D. The second housing 51 moves to the back lower side by each protrusion 51C moving along the second cam groove 54E. That is, the cam portions 54C relatively move the second housing 51 in the connection direction (front-rear direction) intersecting the approach direction (vertical direction) with respect to the first housing 31. In this way, the tabs 52A of the male terminal fittings 52 are inserted into the connecting portions 32A of the female terminal fittings 32 and the male terminal fittings 52 and the female terminal fittings 32 are electrically connected (see FIG. 16).

Then, as shown in FIG. 16, the lower surface of the accommodating portion 53A of the moving plate 53 contacts the upper surface of the bottom wall portion 54A of the guide member 54 and a connecting operation of the first and second housings 31, 51 is completed. With the connecting operation of the first and second housings 31, 51 completed, the protrusions 53C, 51C are located in the lower end parts of the first and second cam grooves 54D, 54E (see FIG. 1). Even if the positions in the vertical direction of the facing portion P and the base portion B vary in such a range that the protrusions 53C, 51C are located in the lower end parts of the first and second cam grooves 54D, 54E (zones extending in the vertical direction of the first and second cam grooves 54D, 54D), the protrusions 53C, 51C are not guided in the front-rear direction. Thus, relative positions of the male and female terminal fittings 52, 32 do not change in the front-rear direction. The position of the moving plate 53 with respect to the second housing 51 at this time is a connection position. That is, the moving plate 53 is movable to the initial position and the connection position.

If the facing portion P is separated upward from the base portion B, the support member 33, the first housing 31, the moving plate 53 and the second housing 51 move upward together with the facing portion P. The first and second housings 31, 51 relatively move away from each other in the front-rear direction in an upward moving process. If the protrusions 53C, 51C reach the first and second parallel zones 54G, 54H (see FIG. 15), the first housing 31 is separated from the second housing 51. Specifically, the support member 33 and the first housing 31 move upward together with the facing portion P, leaving the moving plate 53 and the second housing 51. In this way, the first and second connectors 30, 50 are capable of approaching and separating from each other in the vertical direction.

Next, effects of this configuration are illustrated.

The connector device 10 is provided with the first and second connectors 30, 50 capable of approaching and separating from each other. The first connector 30 includes the first housing 31. The second connector 50 includes the second housing 51 connectable to the first housing 31, the moving plate 53 to be positioned with respect to the first housing 31 and the guide member 54 for movably supporting the moving plate 53 and the second housing 51. The first housing 31 includes the positioning receiving portion 31F, and the moving plate 53 includes the positioning portion 53F to be engaged with the positioning receiving portion 31F in the approach direction of the first and second connectors 30, 50. With the moving plate 53 positioned with respect to the first housing 31, the first and second housings 31, 51 are arranged at the connection start position. The guide member 54 includes the cam portions 54C for moving the second housing 51 in the connection direction (front-rear direction) intersecting the approach direction with respect to the first housing 31.

According to this configuration, after the first and second housings 31, 51 are arranged at the connection start position by the moving plate 53, the second housing 51 can be moved in the connection direction by the cam portions 54C of the guide member 54. At this time, relative position variations of the first and second housings 31, 51 can be suppressed to be small, and the first and second housings 31, 51 tend to be satisfactorily connected. That is, since the second connector 50 includes the moving plate 53, the positioning accuracy of the first and second connectors 30, 50 can be enhanced.

A positioning member is the moving plate 53 movable to the initial position and the connection position with respect to the second housing 51 and configured to protect the tabs 52A of the male terminal fittings 52 mounted in the second housing 51 at the initial position. According to this configuration, since the first and second housings 31, 51 are arranged at the connection start position with the moving plate 53 positioned with respect to the first housing 31, the connecting operation of the first and second housings 31, 51 thereafter can be satisfactorily performed. That is, the moving plate 53 can have a positioning function with respect to the first housing 31 in addition to a function of protecting the tabs 52A.

The first connector 30 includes the support member 33 for movably supporting the first housing 31 in the direction intersecting the approach direction. According to this configuration, the first housing 31 is movable in the direction intersecting the approach direction with respect to the support member 33. Thus, even if the second connector 50 swings with respect to the first connector 30 while the connection of the first and second housings 31, 51 proceeds, the first housing 31 can follow the second housing 51 and the connection of the first and second housings 31, 51 is not hindered.

The positioning portion 53F is in the form of a shaft extending in the approach direction, and the positioning portion 53F and the positioning receiving portion 31F include the rotation restricting portion 40 for restricting the rotation of the positioning portion 53F about the axis with respect to the positioning receiving portion 31F. According to this configuration, an operation of bringing the first and second housings 31, 51 closer is easily stabilized.

### <Other Embodiments>

The embodiment disclosed this time should be considered illustrative in all aspects, rather than restrictive. The scope of the present invention is not limited to the embodiment disclosed this time, but is represented by claims and intended to include all changes in the scope of claims and in the meaning and scope of equivalents.

Unlike this embodiment, a positioning receiving portion may be provided with a rotation restricting recess and a positioning portion may be provided with a rotation restricting protrusion. Further, a moving plate may be provided with a positioning receiving portion and a first housing may be provided with a positioning portion.

Unlike this embodiment, a support member may not be provided.

Unlike this embodiment, a base portion and a facing portion are not limited to parts of a vehicle, but may be members to be mounted by being brought closer to each other.

The outer shape of a positioning portion is not limited to a cylindrical shape.

### LIST OF REFERENCE NUMERALS

10 . . . connector device
30 . . . first connector
31. . . . first housing
31A . . . first housing body
31E . . . positioning receiving body
31C . . . locking portion
31D . . . first cavity
31E . . . protrusion
31F . . . positioning receiving portion
31G . . . rotation restricting protrusion (rotation restricting portion)
31H . . . flange portion
31J . . . locking lance
31K . . . supporting portion
32 . . . female terminal fitting
32A. . . . connecting portion
32B. . . . barrel portion
32C . . . rubber plug
33 . . . support member
33A . . . base portion
33B . . . resilient deforming portion
33C . . . detachment restricting portion
33D . . . through hole
40 . . . rotation restricting portion
50 . . . second connector
51 . . . second housing
51A . . . second housing body
51B . . . receptacle
51C . . . protrusion
51D . . . second cavity
51E . . . first wall portion
51F . . . second wall portion
51G . . . locking lance
52 . . . male terminal fitting
52A . . . tab
52B . . . barrel portion
52C . . . rubber plug
53 . . . moving plate (positioning member)
53A . . . accommodating portion
53B . . . moving plate body
53C . . . protrusion
53D . . . recess
53E . . . gap
53F . . . positioning portion
53G . . . rotation restricting recess (rotation restricting portion)
53H . . . insertion hole
53J . . . lightening portion
54 . . . guide member
54A . . . bottom wall portion
54B . . . left/right side wall portion
54C . . . cam portion
54D . . . first cam groove (cam portion)
54E . . . second cam groove (cam portion)
54F . . . reinforcement column
54G . . . first parallel zone
54H . . . second parallel zone
54J . . . intermediate parallel zone
B . . . base portion
M1 . . . first mounting surface
M2 . . . second mounting surface
P . . . facing portion
S . . . swing space
W1, W2 . . . wire

1. A connector device, comprising a first connector and a second connector capable of approaching and separating from each other,
the first connector including a first housing,
the second connector including a second housing connectable to the first housing, a positioning member to be positioned with respect to the first housing and a guide member for movably supporting the positioning member and the second housing,
the first housing including a positioning receiving portion,
the positioning member including a positioning portion to be engaged with the positioning receiving portion in an approach direction of the first and second connectors,
the first and second housings being arranged at a connection start position with the positioning member positioned with respect to the first housing, and
the guide member including a cam portion for moving the second housing in a connection direction intersecting the approach direction with respect to the first housing.

2. The connector device of claim 1, wherein the positioning member is a moving plate movable to an initial position and a connection position with respect to the second housing, the moving plate protecting a tab of a male terminal fitting mounted in the second housing at the initial position.

3. The connector device of claim 1, wherein the first connector includes a support member for movably supporting the first housing in a direction intersecting the approach direction.

4. The connector device of claim 1, wherein:
the positioning portion is in the form of a shaft extending in the approach direction, and
the positioning portion and the positioning receiving portion include a rotation restricting portion for restricting rotation of the positioning portion about an axis with respect to the positioning receiving portion.
